(19) United States
(12) Patent Application Publication
(10) Pub. No.: US 2010/0027158 A1
(43) Pub. Date: Feb. 4, 2010

(54) Magnetic head for high-frequency field assist recording and magnetic recording apparatus using magnetic head for high-frequency field assist recording

(75) Inventors: Masayuki Takagishi, Tokyo (JP); Kenichiro Yamada, Tokyo (JP); Hitoshi Iwasaki, Yokosuka-Shi (JP); Tomomi Funayama, Tokyo (JP); Masahiro Takashita, Yokohama-Shi (JP); Mariko Shimizu, Yokohama-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/461,027

(22) Filed: Jul. 29, 2009

(30) Foreign Application Priority Data
Jul. 31, 2008 (JP) 2008-198167

(51) Int. Cl. G11B 5/596; G11B 5/127

(52) U.S. Cl. 360/77.02; 360/319

(57) ABSTRACT

A magnetic recording head includes: a magnetic pole; a magnetic shield forming a magnetic circuit with the magnetic pole; and a spin torque oscillator provided between the magnetic pole and the magnetic shield, and formed with a stack structure including a first magnetic layer, a second magnetic layer, and an intermediate layer interposed between the first magnetic layer and the second magnetic layer. The first magnetic layer is made of a magnetic material of 200 Oe or smaller in coercive force. A cross-sectional area of the first magnetic layer in a direction perpendicular to a stack layer face of the first magnetic layer is four or more times greater than a cross-sectional area of the second magnetic layer in a direction perpendicular to a stack layer face of the second magnetic layer.

### CROSS-REFERENCE TO RELATED APPLICATION

This application is based upon and claims the benefit of priority from prior Japanese Patent Application No. 2008-198167 filed on Jul. 31, 2008 in Japan, the entire contents of which are incorporated herein by reference.

### BACKGROUND OF THE INVENTION

1. Field of the Invention

The present invention relates to a magnetic head for high-frequency field assist recording that is suitable for data storage of high recording density, high recording capacity, and a high data transfer rate. The present invention also relates to a high-frequency assist magnetic recording apparatus.

2. Related Art

In 1990's, there were dramatic increases in recording density and recording capacity of an HDD (Hard Disk Drive), as MR (Magneto-Resistive effect) heads and GMR (Giant Magneto-Resistive effect) heads were put into practical use. However, the recording density increase rate temporarily became lower in the beginning of the 2000's, since the problem of heat fluctuations of magnetic recording media rose up to the surface. Recently, the HDD recording density has been increasing about 40% per annum, as the vertical magnetic recording that was more suitable for high-density recording in principle than horizontal magnetic recording was put into practical use in 2005.

In the latest recording density demonstration experiment, a higher level than the 400 Gbits/inch² level has been reached. If the progress continues at this rate, recording density of 1 Tbits/inch² is expected to be reached around the year 2012. However, achieving such high recording density is considered not easy even by a vertical magnetic recording method, as the problem of heat fluctuations will surface again.

As a recording method to solve the above problem, a “high-frequency field assist recording method” has been suggested. By the high-frequency field assist recording method, a high-frequency magnetic field that is much higher than a recording signal frequency and is close to the resonance frequency of the magnetic recording medium is locally induced. As a result, the magnetic recording medium resonates, and the coercive force Hc of the magnetic recording medium having the high-frequency magnetic field induced therein is made equal to or less than half the initial coercive force. Therefore, by overlapping the recording magnetic field with the high-frequency magnetic field, magnetic recording can be performed on a magnetic recording medium that has much higher coercive force Hc and much greater magnetic anisotropic energy Ku (see U.S. Pat. No. 6,011,664, for example). By the technique disclosed in the U.S. Pat. No. 6,011,664, however, the high-frequency magnetic field is generated from a coil, and it is difficult to efficiently induce the high-frequency magnetic field at the time of high-density recording.

As a technique for generating a high-frequency magnetic field, a technique that involves a spin torque oscillator has been suggested (see U.S. Patent Application Publication Nos. 2005/0023938 and 2005/0219771, for example). According to the techniques disclosed in U.S. Patent Application Publication Nos. 2005/0023938 and 2005/0219771, the spin torque oscillator includes a spin injection layer, a nonmagnetic layer, a magnetic layer, and a pair of electrode layers that sandwich those layers. When a direct current flows into the spin torque oscillator through the pair of electrode layers, the magnetization of the magnetic layer ferromagnetically resonates by virtue of the spin torque generated from the spin injection layer. As a result, a high-frequency magnetic field is generated from the spin torque oscillator.

Since the size of the spin torque oscillator is several tens of nanometers, the generated high-frequency magnetic field locally exists at a distance of several tens of nanometers from the spin torque oscillator. Further, the in-plane components (the horizontal components) of the high-frequency magnetic field can efficiently cause a vertically-magnetized magnetic recording medium to resonate, and the coercive force of the magnetic recording medium can be greatly reduced. As a result, high-density magnetic recording is performed only on the region where the recording magnetic field generated from the magnetic pole is overlapped with the high-frequency magnetic field generated from the spin torque oscillator. Accordingly, it becomes possible to use a magnetic recording medium having high coercitivity Hc and large magnetic anisotropic energy Ku. Thus, the problem of heat fluctuations to be caused at the time of high-density recording can be avoided.

A spin torque oscillator is normally located in a position interposed between a magnetic pole and a magnetic shield. In such a spin torque oscillator of a spin reversal type interposed between a magnetic pole and a magnetic shield, 0.3 to 0.5 nanoseconds are required for a reversal of the spin torque oscillator. As of today, the maximum usable frequency of 3.5-inch hard disks is approximately 1 GHz, and therefore, the time consumed by spin reversals presents a serious problem in practice.

### SUMMARY OF THE INVENTION

The present invention has been made in view of these circumstances, and an object thereof is to provide a magnetic recording head for high-frequency field assist recording that can minimize the time required for a reversal of a spin torque oscillator, and a magnetic recording apparatus that uses the magnetic recording head.

A magnetic recording head for high-frequency field assist recording according to a first aspect of the present invention includes: a magnetic pole; a magnetic shield that forms a magnetic circuit with the magnetic pole; and a spin torque oscillator that is provided between the magnetic pole and the magnetic shield, and is formed with a stack structure including a first magnetic layer, a second magnetic layer, and an intermediate layer interposed between the first magnetic layer and the second magnetic layer, the first magnetic layer being made of a magnetic material of 200 Oe or smaller in coercive force, and a cross-sectional area of the first magnetic layer in a direction perpendicular to a stacking direction of the first magnetic layer being four or more times greater than a cross-sectional area of the second magnetic layer in a direction perpendicular to, a stacking direction of the second magnetic layer.

A magnetic recording head for high-frequency field assist recording according to a second aspect of the present invention includes: a magnetic pole; a magnetic shield that forms a magnetic circuit with the magnetic pole; and a spin torque oscillator that is provided between the magnetic pole and the magnetic shield, and is formed with a stack structure including a first magnetic layer, a second magnetic layer, and an intermediate layer interposed between the first magnetic layer and the second magnetic layer, the first magnetic layer being made of a magnetic material containing at least one element selected from the group consisting of Co, Ni, and Fe, and a cross-sectional area of the first magnetic layer in a direction perpendicular to a stacking direction of the first magnetic layer being four or more times greater than a cross-sectional area of the second magnetic layer in a direction perpendicular to a stacking direction of the second magnetic layer.

A magnetic recording apparatus according to a third aspect of the present invention includes: a magnetic recording medium; the magnetic head for high-frequency field assist recording according to the second aspects; a motion control unit that controls the magnetic recording medium and the magnetic head to relatively move while facing each other in a floating or contact state; a position control unit that controls the magnetic head to be located at a predetermined recording position on the magnetic recording medium; and a signal processing unit that performs processing on a signal for writing on the magnetic recording medium and a signal for reading from the magnetic recording medium, using the magnetic head.

### BRIEF DESCRIPTION OF THE DRAWINGS

FIG. 1 is a cross-sectional view of a magnetic head having a spin torque oscillator;

FIGS. 2(a) through 2(e) are cross-sectional views illustrating a perpendicular recording method that does not involve high-frequency field assist recording;

FIG. 3 is a cross-sectional view illustrating a perpendicular recording method that involves high-frequency field assist recording;

FIG. 4 is a plan view showing the structure of a spin torque oscillator;

FIGS. 5(a) and 5(b) are diagrams for explaining the problem caused in a case where high-frequency field assist recording is performed with the use of a spin torque oscillator;

FIGS. 6(a) and 6(b) are diagrams for explaining high-frequency field assist recording to be performed with the use of a spin torque oscillator of a pin flip type;

FIGS. 7(a) to 8(b) are diagrams for explaining problems caused in a case where high-frequency field assist recording is performed with the use of a spin torque oscillator of a pin flip type;

FIGS. 9(a) and 9(b) are plan views of a spin torque oscillator in accordance with an embodiment;

FIG. 10 is a plan view schematically showing the structure of a magnetic head in accordance with a first embodiment;

FIG. 11 is a plan view schematically showing the structure of a magnetic head in accordance with a second embodiment;

FIG. 12 is a plan view schematically showing the structure of a magnetic head in accordance with a third embodiment;

FIG. 13 is a perspective view schematically showing the structure of a magnetic recording apparatus in accordance with a fourth embodiment;

FIG. 14 is a perspective view showing a head stack assembly having a head slider mounted thereon;

FIGS. 15(a) and 15(b) are views illustrating a first specific example of a magnetic recording medium; and

FIGS. 16(a) and 16(b) are views illustrating a second specific example of a magnetic recording medium.

### DETAILED DESCRIPTION OF THE INVENTION

First, the background to the present invention is explained, before embodiments of the present invention are described.

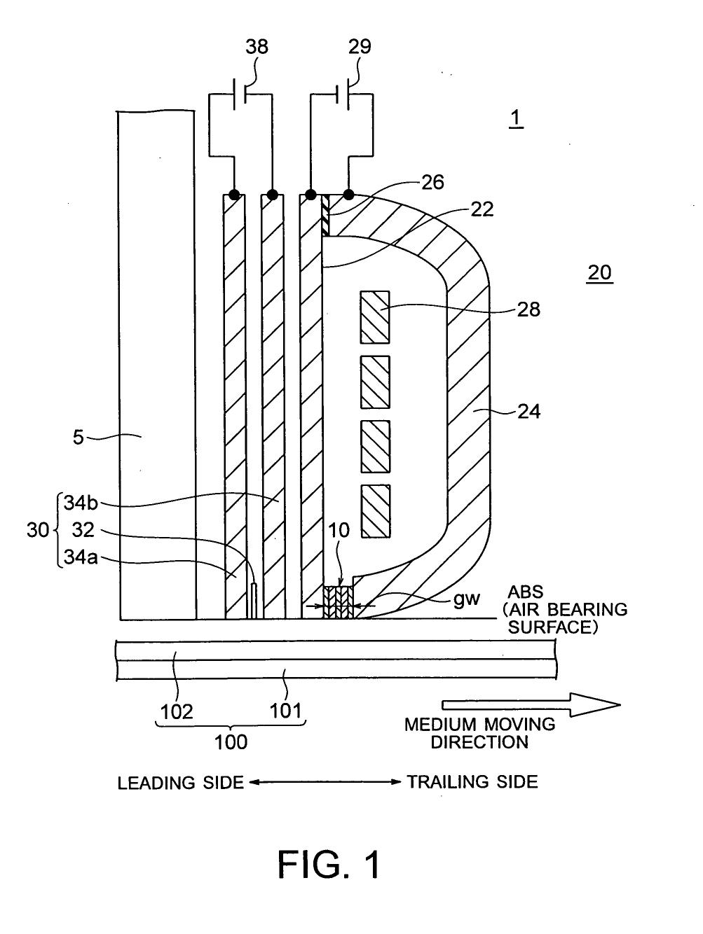

In a case where a magnetic head having a spin torque oscillator is seen in a cross section perpendicular to the surface facing the medium, the magnetic head is mounted in the manner illustrated in FIG. 1. More specifically, the magnetic head 1 includes a reproducing unit 30 formed on a substrate 5, and a recording unit 20 formed on the reproducing unit 30. The surface existing in a direction perpendicular to the plane of the substrate 5 is the air bearing surface (hereinafter also referred to as the ABS) facing a magnetic recording medium 100. The magnetic recording medium 100 has a perpendicular magnetic recording layer 102 formed on a backing layer 101. FIG. 1 is a cross-sectional view of the magnetic head, taken along a plane substantially perpendicular to the surface of the magnetic recording medium 100.

The reproducing unit 30 includes a reproducing element 32, and a pair of electrodes 34a and 34b that sandwich the reproducing element 32 and are electrically connected to the reproducing element 32. The electrodes 34a and 34b extend parallel to the substrate 5. A power supply 38 that supplies current to the reproducing element 32 is connected to the pair of electrodes 34a and 34b.

The recording unit 20 includes a magnetic pole (a recording magnetic pole) 22, a magnetic shield 24, an insulating layer 26, and a magnetizing coil 28 that magnetizes the magnetic pole 22. The magnetic pole 22 and the magnetic shield 24 are arranged, with a write gap g_{w} being formed on the ABS side. A spin torque oscillator 10 is provided at the write gap g_{w}. The spin torque oscillator 10 is electrically connected to the magnetic pole 22 and the magnetic shield 24. An insulating layer 26 is provided on the opposite end portion from the ABS. At this end portion, the magnetic pole 22 and the magnetic shield 24 are electrically insulated from each other, but are magnetically connected to each other. Further, the magnetic pole 22 and the magnetic shield 24 are electrically connected to a power supply 29, so as to supply current to the spin torque oscillator 10.

In a regular magnetic head of a perpendicular magnetic recording type, the magnetic shield 24 is placed on the trailing side of the magnetic pole 22 (or the moving direction side of the magnetic recording medium 100). However, the spin torque oscillator 10 needs to be placed near the magnetic pole 22, as will be described later.

Therefore, the spin torque oscillator 10 is inserted to the gap g_{w} interposed between the magnetic pole 22 and the magnetic shield 24.

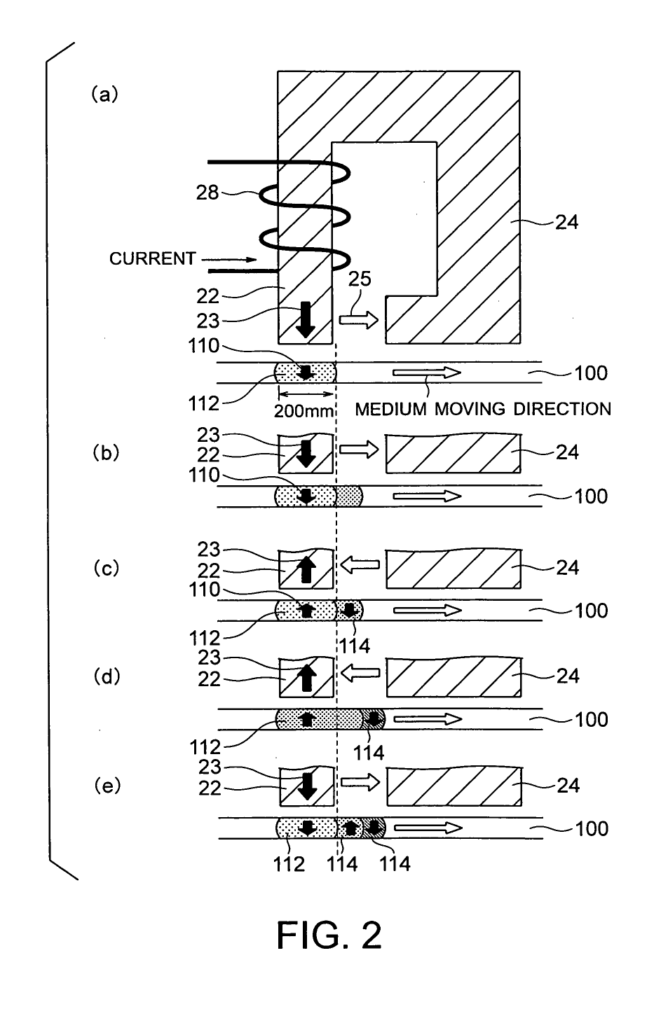

Next, the necessity of the spin torque oscillator 10 near the magnetic pole 22 is explained. First, referring to FIGS. 2(a) through 2(e), a conventional perpendicular recording method that does not involve high-frequency magnetic field assisting operations is described. FIGS. 2(a) and 2(b) are cross-sectional views of a magnetic head, taken along a plane substantially perpendicular to the surface of the magnetic recording medium 100. FIG. 2(a) schematically shows only the recording unit 20, but does not show the spin torque oscillator 10 shown in FIG. 1. When a current is supplied to the magnetizing coil 28, the magnetization 23 of the magnetic pole 22 is directed downward (the direction from the magnetic pole 22 toward the magnetic recording medium 100), for example. At this point, a gap magnetic field 25 that extends from the magnetic pole 22 toward the magnetic shield 24 via the gap g_{w} is generated. A portion having a large downward magnetic field is generated in the magnetic recording medium 100 immediately below the magnetic pole 22. Of this portion, a larger magnetic field portion 112 that reverses the magnetization 110 of the magnetic recording medium 100 is called a write bubble 112. Since the length of the magnetic pole 22 in the moving direction of the medium 100 is approximately 200 nm, the write bubble 112 is also approximately 200 nm in size. While the current flowing direction (the polarity) of the exciting coil 28 remains the same, the portion that has passed through the write bubble 12 of the magnetic recording medium 100 is magnetized in the same direction as the magnetization 23 of the magnetic pole 22 (see FIG. 2(b)), as the magnetic recording medium 100 moves along. When the polarity of the exciting coil 28 is reversed, the magnetization 110 in the write bubble 112 is magnetized in the opposite direction from the previous magnetization direction. At this point, a recording pattern 114 is formed on the trailing side of the write bubble 112 for the first time (see FIG. 2(c)). By reversing the polarity of the magnetizing coil 28, recording patterns 114 are formed on the trailing side of the write bubble 112 one by one (see FIGS. 2(d) and 2(e)).

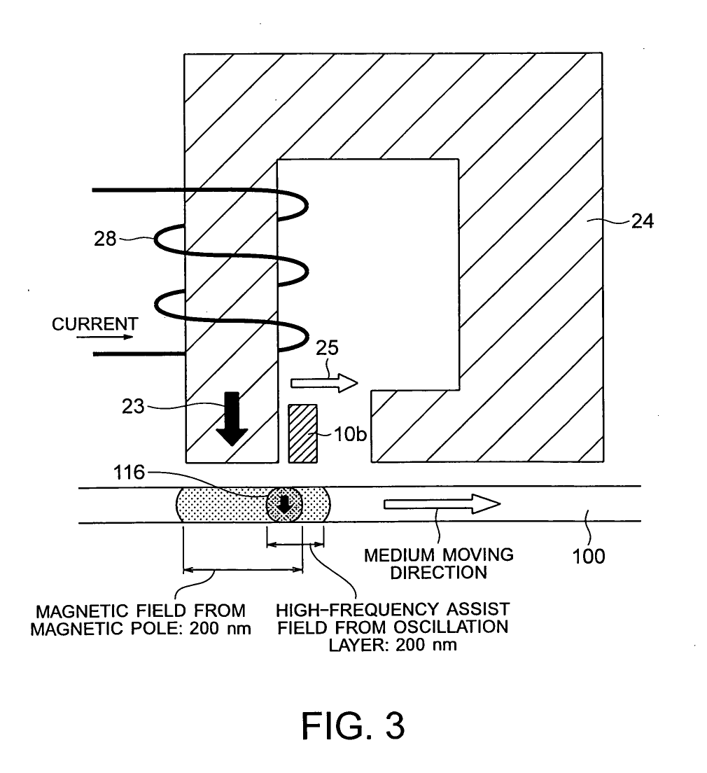

FIG. 3 schematically shows a magnetic head that has the spin torque oscillator 10 inserted to the write gap g_{w}. FIG. 3 is a cross-sectional view of the magnetic head, taken along a plane substantially perpendicular to the surface of the magnetic recording medium 100. For ease of explanation, the spin torque oscillator 10 only has an oscillation layer 10b in FIG. 3. The thickness of the oscillation 10b is preferably in the range of 5 nm to 30 nm, so that the extent of the high-frequency assist magnetic field is restricted to approximately 20 nm, which is one tenth of the length of the magnetic pole 22, approximately 200 nm. In a high-frequency field assist recording operation, the overlapping portion between the magnetic field of the magnetic pole 22 and the assist magnetic field serves as a write bubble 116, and therefore, the write bubble 116 needs to be located closer, compared with the magnetic pole 22 of 200 nm to 300 nm in length and the write gap g_{w} of 50 nm to 100 nm in length. Once the write bubble for high-frequency field assist recording is formed, the same recording operation as a conventional perpendicular magnetic recording operation is performed, except for the size of the write bubble.

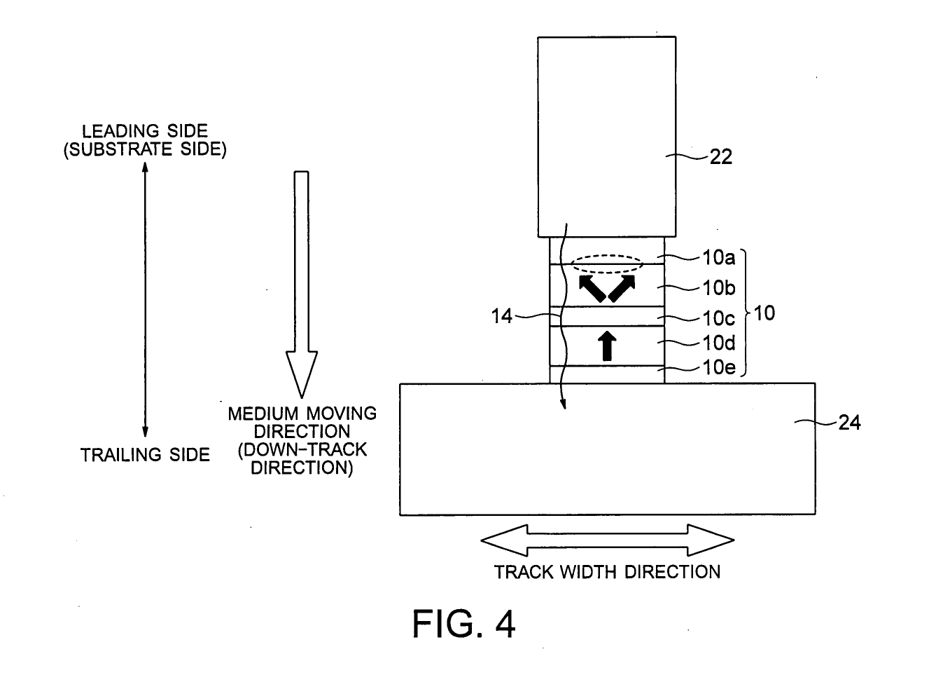

FIG. 4 illustrates the structure of the spin torque oscillator 10. FIG. 4 is a plan view of the magnetic head, seen from the air bearing surface. The spin torque oscillator 10 includes at least an oscillation layer 10b, a nonmagnetic layer (an intermediate layer) 10c, and a spin injection layer 10d, with electrodes 10a and 10e sandwiching the oscillation layer 10b, the nonmagnetic layer 10c, and the spin injection layer 10d. A uniaxial anisotropy field Hk is normally induced into the two magnetic layers 10b and 10d, and is adjusted so that the magnetization directions of the two magnetic layers 10b and 10d become parallel or antiparallel to each other. In a case where the magnetization directions of the oscillation layer 10b and the spin injection layer 10d are parallel to each other, electrons 14 are introduced from the oscillation layer 10b into the spin injection layer 10d. In doing so, the electrons having the spin in the opposite direction from the magnetization of the spin injection layer 10d are often reflected by the interface between the intermediate layer 10c and the spin injection layer 10d. Having the spin in the opposite direction from the magnetization of the oscillation layer 10b, the reflected electrons 14 interfere with the magnetization of the oscillation layer 10b, and cause the magnetization of the oscillation layer 10b to oscillate. If the magnetization of the spin injection layer 10d varies in such a case, the oscillation of the oscillation layer 10b is hindered. Therefore, the anisotropy field Hk of the spin injection layer 10d is made larger or the like, so as to stabilize the magnetization of the spin injection layer 10d.

The oscillation frequency of the oscillation layer 10b is equal to the value obtained by multiplying the effective magnetic field Heff by γ (gyro constant). The effective magnetic field is expressed by the following equation:

H_{eff}=Hₖ−Hdₒₛ+Hdᵢₙⱼ±H_{gap} (1)

Here, Hₖ represents the value of the anisotropy field of the oscillation layer 10b, Hdₒₛ and Hdᵢₙⱼ represent the values of the demagnetizing fields of the oscillation layer 10b and the spin injection layer 10d, and H_{gap} represents the value of the gap magnetic field 25.

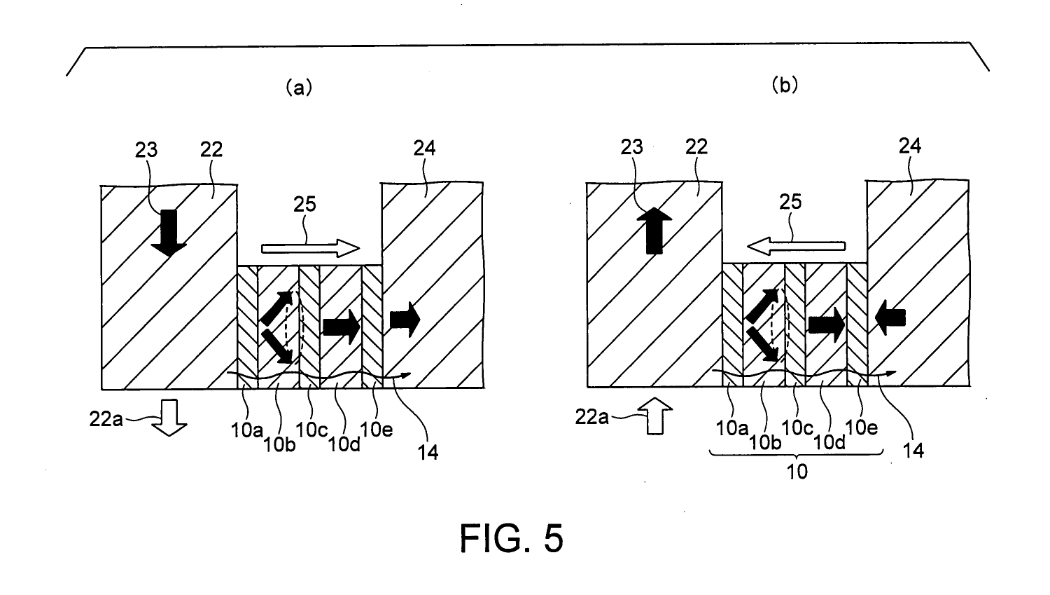

As can be seen from the recording procedures illustrated in FIG. 2, the gap magnetic field 25 is reversed, as the direction of the magnetization 23 of the magnetic pole 22 (or the direction of the magnetic filed 22a from the magnetic pole 22) is reversed (see FIGS. 5(a) and 5(b)). Accordingly, the effective magnetic field varies by 2×Hgap in the recording process. Hgap is approximately 5 kOe to 20 kOe. Since the total of the magnetic fields of the terms other than Hgap is approximately 40 kOe to 50 kOe, the effective magnetic field varies by 20% to 100%. Since the frequency of the high-frequency assist magnetic field also varies by the same amount, this variation is fatal to high-frequency field assist recording operations in which the frequency of the oscillation layer 10b is adjusted to the resonant frequency of the magnetic recording medium 100. FIGS. 5(a) and 5(b) are cross-sectional views of the magnetic head, taken along a plane substantially perpendicular to the surface of the magnetic recording medium.

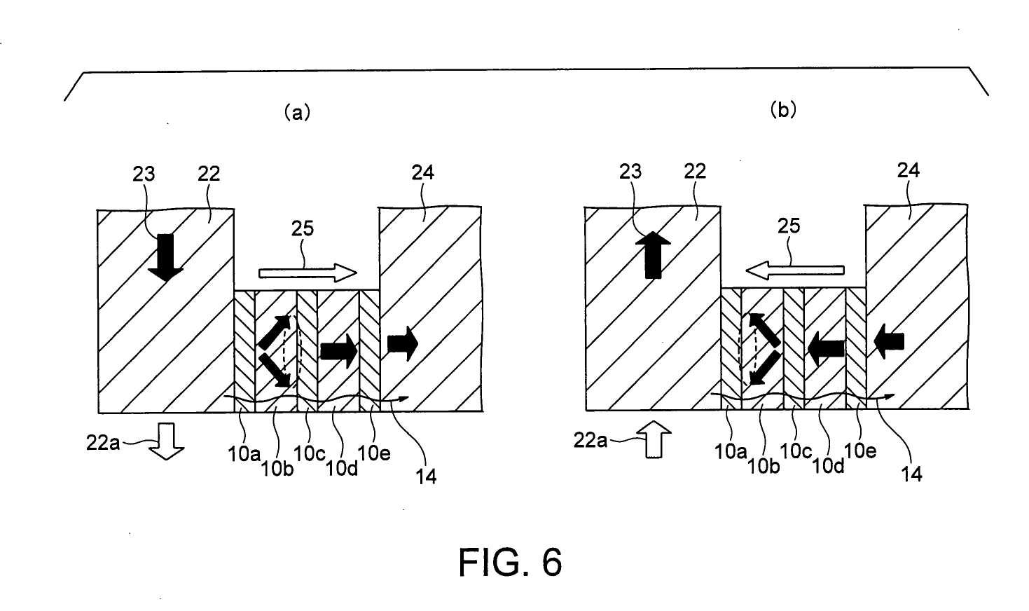

As a means to avoid the above problem, a spin torque oscillator of a pin flip type has been known. A spin torque oscillator of a pin flip type is a spin torque oscillator that is controlled by making the coercive force of the spin injection layer 10d smaller than the gap magnetic field 25, so that the spin injection layer 10d is reversed when the gap magnetic field 25 is reversed. At this point, the coercive force of the oscillation layer 10b is made smaller than the coercive force of the spin injection layer 10d, so as to facilitate rotation of the oscillation layer 10b. In this manner, as shown in FIGS. 6(a) and 6(b), the relationship between the direction of the gap magnetic field 25 and the magnetization directions of the oscillation layer 10b and the spin injection layer 10d remains the same. Accordingly, the effective magnetic field or the resonant frequency of the oscillation layer 10b is maintained. FIGS. 6(a) and 6(b) are cross-sectional views of the magnetic head, taken along a plane substantially perpendicular to the surface of the magnetic recording medium.

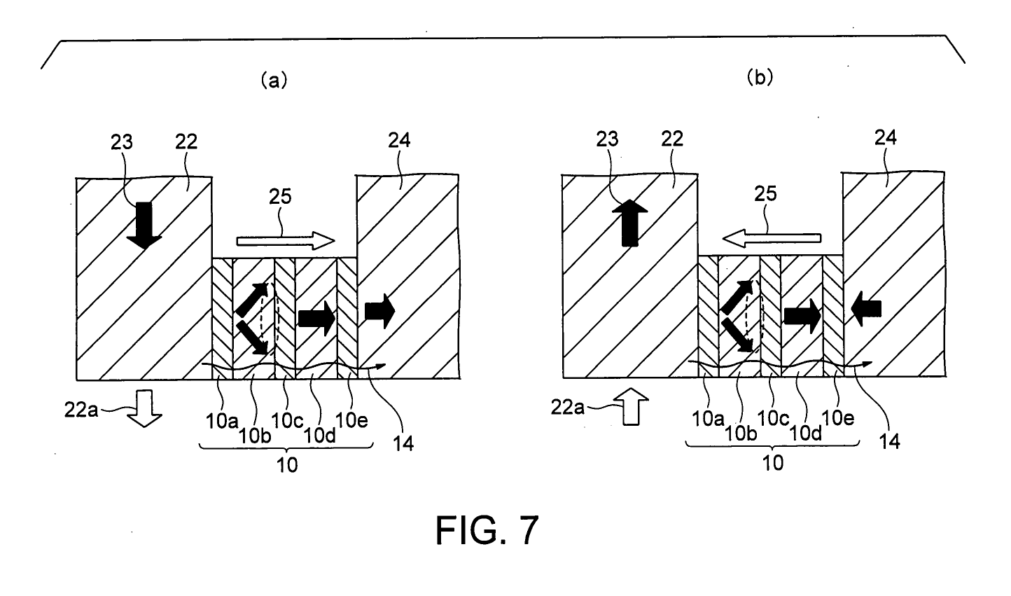

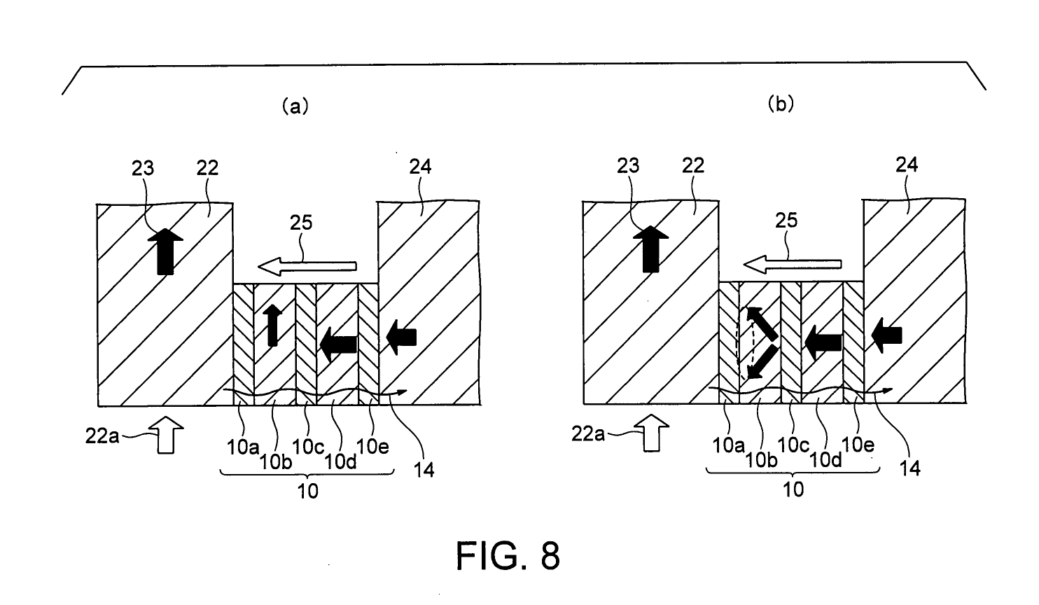

However, the spin torque oscillator 10 of a pin flip type has a problem in the spin reversal time of the oscillation layer 10b. FIGS. 7(a) through 8(b) are schematic views showing the spin torque oscillator observed before and after the magnetic field 22a generated from the magnetic pole 22 is reversed. FIGS. 7(a) through 8(b) are cross-sectional views of the magnetic head, taken along a plane substantially perpendicular to the surface of the magnetic recording medium. As shown in FIGS. 7(a) and 7(b), the magnetization 23 of the magnetic pole 22 is reversed. At the same time, the gap magnetic field 25 induced in the spin torque oscillator 10 is reversed. Normally, 0.2 nanoseconds to 0.5 nanoseconds are required for this reversal.

After the reversal of the spin torque oscillator starts, the spin torque oscillator 10 is put into the state illustrated in FIG. 8(a), and starts a regular operation for the first time (FIG. 8(b)). The time required for the spin torque oscillator 10 to transit from the state shown in FIG. 7(b) to the state shown in FIG. 8(a) is approximately 0.5 nanoseconds. As of today, the maximum usable frequency of 3.5-inch hard disks is approximately 1 GHz, and merely a reversal of the magnetic pole 22 tends to cause a problem. Therefore, when the magnetic head is used for a high-density hard disk, the time consumed by spin reversals presents a serious problem in practice.

To counter this problem, the inventors made intensive studies, and reached the following conclusions.

First, the inventors consider that the hard magnetism or the high coercive force of the spin injection layer 10d is a cause of the increase in reversal time. To reduce the coercive force of the spin injection layer 10d, the spin injection layer 10d is turned into a soft magnetic layer. In this case, the soft magnetic material of the shield is reversed quicker than the spin injection layer 10d. Therefore, a soft magnetic material has the same level of soft magnetism as the shield layer, or has a coercive force of 200 Oe or smaller, as a material having a coercive force of 200 Oe or smaller is used as the shielding material. Also, it is preferable that, like the shielding material, the spin injection layer is formed with a magnetic material containing at least one element selected from the group consisting of Co, Ni, and Fe, as a main component.

In a case where the spin injection layer 10d is not stabilized, oscillation of the oscillation layer 10b is hindered, as described above. Therefore, even if the spin injection layer 10d is a soft magnetic layer, it is necessary to take measures to stabilize the spin injection layer 10d. To ferromagnetically couple the spin injection layer 10d to an antiferromagnetic material or a ferromagnetic material or the like is substantially the same as to increase the coercive force of the spin injection layer 10d. Therefore, the problem of the reversal time cannot be solved.

One of the solutions against the reversal time problem is making the cross-sectional area of the spin injection layer 10d larger than the cross-sectional area of the oscillation layer 10b. One of the reasons that the spin injection layer 10d is not stabilized is that the electrons spin-polarized in the oscillation layer 10b flow into the spin injection layer 10d, and the polarized electrons and the spin injection layer 10d interact with each other to cause the spin injection layer 10d to oscillate. The magnetization stability with respect to the spin torque in the spin injection layer 10d is determined by the critical current density Jc, which is expressed by the following equation (2):

Jc=(Hex+Hk−Hd)×α×e×Ms×δ/(pₒ×h/(2π)) (2)

Here, Hex represents the external magnetic field, Hk represents the uniaxial anisotropy field of the spin injection layer 10d, Hd represents the demagnetizing field of the spin injection layer 10d, Ms represents the saturation magnetization of the spin injection layer 10d, α represents the damping constant, δ represents the film thickness of the spin injection layer 10d, e represents the elementary charge, pₒ represents the polarity (=(up-spin electron density−down-spin electron density)/(total electron density)), and h represents the Planck's constant. The critical current is 2.0×10⁷ (A·cm²) to 10.0×10⁷ (A·cm²), and is approximately 2.5×10⁷ (A·cm²) in a typical soft magnetic material containing Fe or Co.

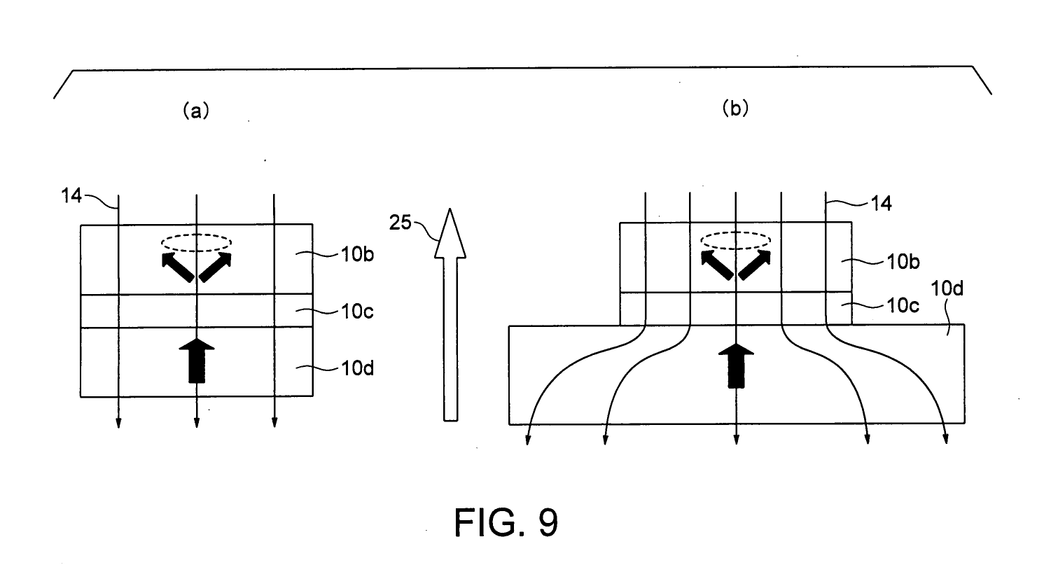

To cause the oscillation layer 10b to oscillate in a stable manner, high current density in the neighborhood of 5.0×10⁷ (A·cm²) to 30.0×10⁷ (A·cm²) is required. A typical value to be used in the oscillation layer 10b is approximately 10.0×10⁷ (A·cm²). To cause the oscillation layer 10b to oscillate in a stable manner and restrict the current density of the spin injection layer 10d to the critical current density Jc or lower, the critical current density Jc of the spin injection layer 10d is made higher by adjusting the uniaxial anisotropy field Hk and the external magnetic field Hex. In a case where the uniaxial anisotropy fields Hk of the oscillation layer 10b and the spin injection layer 10d and the external magnetic field Hex have the same values, the current density of the spin injection layer 10d should be made four or more times smaller than the current density of the oscillation layer 10b in the above typical example. Normally, the cross-sectional areas in which the current flows are the same between the oscillation layer 10b and the spin injection layer 10d, as shown in FIG. 9(a). However, the cross-sectional area of the spin injection layer 10d should be made four or more times greater than the cross-sectional area of the spin injection layer 10d, as shown in FIG. 9(b). FIGS. 9(a) and 9(b) are plan views of the spin torque oscillator, seen from the air bearing surface.

Also, as described above, when the spin injection layer 10d is ferromagnetically coupled to a hard magnetic layer (such as an antiferromagnetic layer), the reversal time is not improved. As a result, a reversal of the spin injection layer 10d has already been completed when the magnetic pole 22 is reversed in the state shown in FIG. 7(b). If the spin injection layer 10d is ferromagnetically coupled to a magnetic shield layer 24 made of a soft magnetic material, the loss in the reversal time of the spin injection layer 10d becomes so small that can be actually ignored, and the reversal time of the spin torque oscillator 10 is dramatically improved.

The following is a description of embodiments of the present invention, with reference to the accompanying drawings.

### FIRST EMBODIMENT

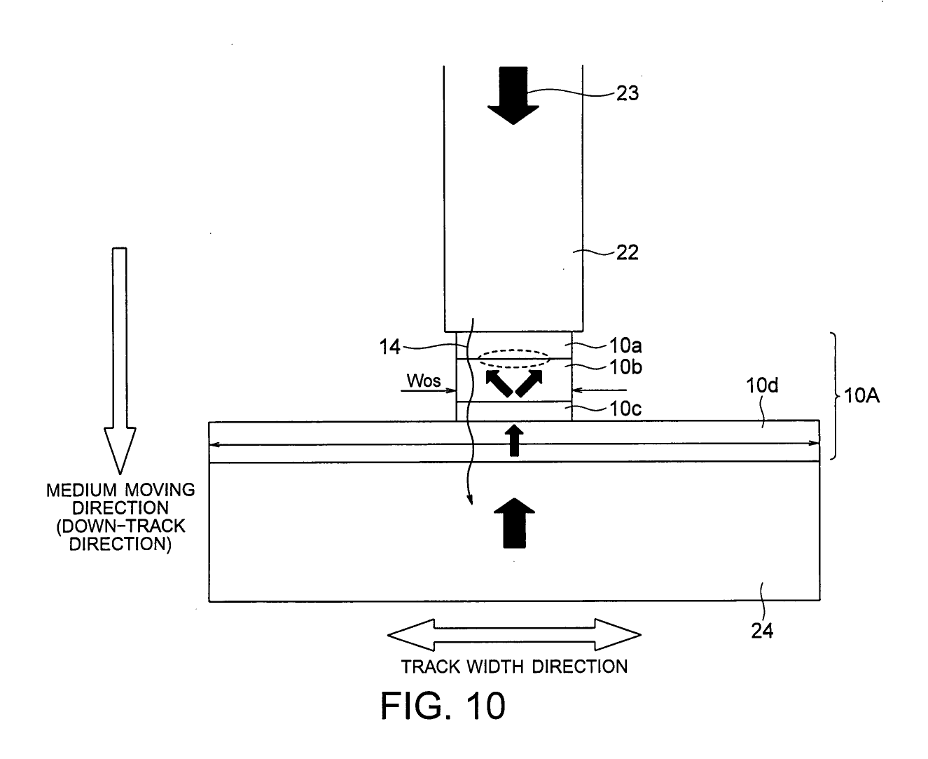

FIG. 10 schematically shows the structure of a magnetic head in accordance with a first embodiment of the present invention. FIG. 10 is a plan view of the magnetic head of this embodiment, seen from the air bearing surface. The magnetic head of this embodiment is the same as the magnetic head of FIG. 1, except that the spin torque oscillator 10 is replaced with a spin torque oscillator 10A shown in FIG. 10.

The spin torque oscillator 10A has a stack structure formed by stacking an electrode 10a, an oscillation layer 10b, an intermediate layer 10c, and a spin injection layer 10d in this order. The opposite face of the electrode 10a from the oscillation layer 10b is in contact with a magnetic pole 22. The spin injection layer 10d is ferromagnetically coupled to a magnetic shield 24. In this embodiment, the electrode 10a, the oscillation layer 10b, and the intermediate layer 10c have film planes of the same size, but the spin injection layer 10d has a larger film plane than the electrode 10a, the oscillation layer 10b, and the intermediate layer 10c. In this specification, “a film plane of a layer” means “a face of the layer in a direction perpendicular to a stacking direction of the layer”. More specifically, the spin injection layer 10d has a film plane of an area four or more times larger than the area of each film plane of the electrode 10a, the oscillation layer 10b, and the intermediate layer 10c. For example, the width Winj of the spin injection layer 10d is designed to be four or more times greater than the width Wos of the oscillation layer 10b. Here, the lengths of the respective layers in the spin torque oscillator 10A in the direction perpendicular to the sheet plane of FIG. 10 are the same.

Like the magnetic head illustrated in FIG. 1, the magnetic head of this embodiment has a trailing direction in the direction from the magnetic pole 22 toward the magnetic shield 24. Although not shown in FIG. 10, a slider substrate is provided above the portion illustrated in FIG. 10. Therefore, the film forming order in the magnetic head of this embodiment is as follows: the magnetic pole 22→the electrode 10a→the oscillation layer 10b→the intermediate layer 10c→the spin injection layer 10d→the magnetic shield 24.

The oscillation layer 10b may be a layer containing at least one element selected from the group of typical soft-magnetic metal elements such as Fe, Co, and Ni, an alloy layer containing two or more elements selected from the group of the typical soft-magnetic metal elements, or a stack structure formed with those layers. It is preferable that the film thickness of the oscillation layer 10b is in the range of 5 nm to 20 nm. A high-conductivity metal material is used as the electrode 10a between the magnetic pole 22 and the oscillation layer 10b. This metal material may be a material that does not easily transmit spin torque, such as Ru, Rh, Pd, Ir, or Pt, so as to restrict spin torque transmission from the magnetic pole 22. It is preferable that the intermediate layer 10c placed between the oscillation layer 10b and the spin injection layer 10d is made of a material having high spin torque transmissibility, such as Cu, Ag, or Au.

It is preferable that the spin injection layer 10d is made of a low-resistance, high-Bs material that facilitates current to diffuse. As described above, the size Winj of the spin injection layer 10d in the width direction is made four or more times greater than the width Wos of the oscillation layer 10b, so that the current density becomes 25% or lower than the current density in the oscillation layer 10b. However, it is preferable that the magnetization in the current diffusion area oscillates in an integrated manner, so that the current diffuses sufficiently and the current density is equivalently lower than the current density of the oscillation layer 10b. Therefore, it is preferable that the spin injection layer 10d is made of a material having a great exchange coupling length Lex, such as an alloy of a soft magnetic material such as Co, Ni, or Fe. The exchange coupling length Lex is proportional to the square root of the exchange stiffness constant of the material. In the case of any of those soft magnetic materials, the exchange coupling length Lex is 5 nm to 15 nm, and it is considered that the magnetization oscillates in an integrated manner in a range approximately twice as large as the exchange coupling length Lex.

By another technique for causing the magnetization to oscillate in an integrated manner, a material with which the spin torque transfer is performed at the longest distance as possible is used. The distance is known as the spin diffusion length λs, which is normally several nanometers to 10 nanometers. In an alloy (CoFeB) formed by mixing an element such as B with CoFe, the spin diffusion length λs is 10 nm or greater.

Where the exchange coupling length Lex is approximately 7 nm and the spin diffusion length λs is approximately 12 nm, the length of the area in which the magnetization of the spin injection layer 10d oscillates in an integrated manner is estimated to be Lex×2+λs (=26 nm), when measured from the end of the oscillation layer 10b. If the oscillation layer 10b has a square shape of W in height and width, the cross-sectional area of the spin injection layer 10d in which the magnetization oscillates in an integrated manner is (26×2+W)² and needs to be greater than four times W². Accordingly, W is limited by the size of the oscillation layer 10b, which is 52 nm or smaller. The width of the oscillation layer 10b is equivalent to recording density of approximately 500 Gbpsi or higher.

In this embodiment, the spin injection layer 10d and the magnetic shield 24 are brought into direct contact with each other, and are ferromagnetically coupled to each other, so as to further improve the reversal time of the spin injection layer 10d. By ferromagnetically coupling the soft-magnetic spin injection layer 10d to the magnetic shield 24 in this manner, the loss in the reversal time of the spin injection layer 10d can be virtually eliminated.

In this embodiment, the spin injection layer 10d also plays the role of the magnetic shield 24, and the write gap g_{w} can be reduced to 20 nm or less, accordingly. Normally, it is preferable that the write gap g_{w} is approximately 40 nm, so as to insert the total thickness of the spin injection layer 10d, the oscillation layer 10b, and the intermediate layer 10c into the write gap g_{w} between the magnetic pole 22 and the magnetic shield 24. However, the write gap needs to be made shorter, as the linear recording density becomes higher. If the gap can be made 20 nm or less, the possibility to achieve higher density becomes even higher.

As described above, in accordance with this embodiment, the reversal time of the spin torque oscillator can be minimized.

### SECOND EMBODIMENT

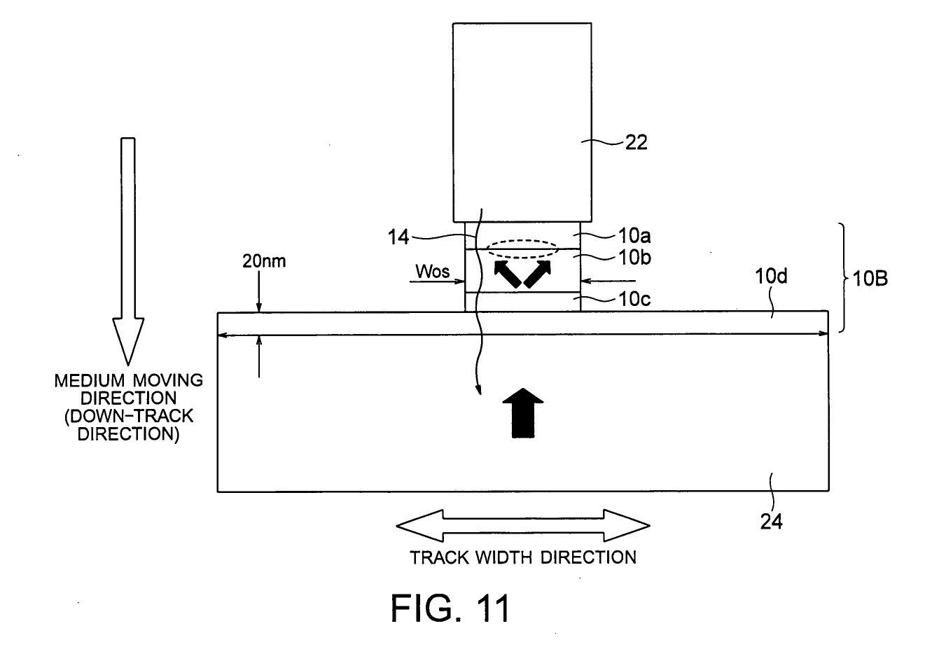

FIG. 11 schematically shows the structure of a magnetic head in accordance with a second embodiment of the present invention. FIG. 11 is a plan view of the magnetic head of this embodiment, seen from the air bearing surface.

The magnetic head of this embodiment is the same as the magnetic head of the first embodiment shown in FIG. 10, except that the spin torque oscillator 10A is replaced with a spin torque oscillator 10B. In the magnetic head of the first embodiment shown in FIG. 10, the spin injection layer 10d and the magnetic shield 24 are made of different materials from each other. In the magnetic head of the second embodiment, on the other hand, the spin injection layer 10d of the spin torque oscillator 10b is made of the same material as the magnetic shield 24, and is integrally formed with the magnetic shield 24. In other words, the magnetic shield 24 also functions as the spin injection layer 10d. In this case, the magnetic shield 24 may be made of an alloy of a soft magnetic material such as Co, Fe, or Ni, or a material having an element such as B added to the alloy, with the exchange coupling length Lex and the spin diffusion length λs being taken into account.

To stabilize the spin injection layer 10d, the cross-sectional area of the spin injection layer 10d (the cross-sectional area of the region in which the magnetization oscillates in an integrated manner) needs to be four or more times greater than the cross-sectional area of the oscillation layer 10b. In this embodiment, however, the magnetic shield 24 also serves as the spin injection layer 10d. Therefore, the cross-sectional area of the region in which the magnetization oscillates in an integrated manner in the magnetic shield 24 should be set with the use of a cross-sectional area measured at a depth of approximately 20 nm from the intermediate layer 10c, as shown in FIG. 11.

In accordance with this embodiment, the reversal time of the spin torque oscillator can be minimized, as in the first embodiment.

### THIRD EMBODIMENT

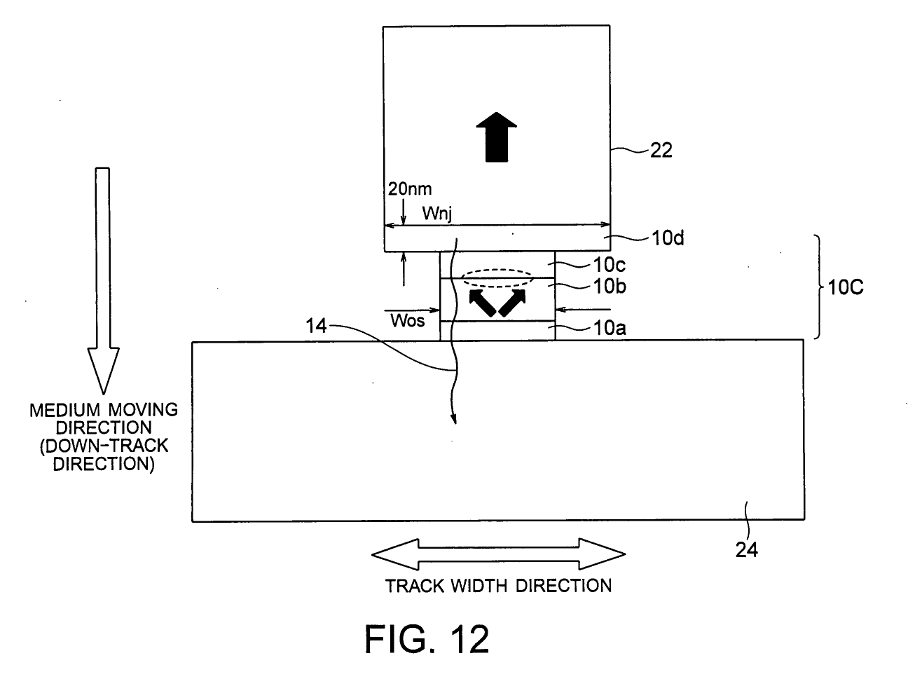

FIG. 12 schematically shows the structure of a magnetic head in accordance with a third embodiment of the present invention. FIG. 12 is a plan view of the magnetic head of this embodiment, seen from the air bearing surface.

The magnetic head of this embodiment is the same as the magnetic head of the first embodiment shown in FIG. 10, except that the spin torque oscillator 10A is replaced with a spin torque oscillator 10C. In the spin torque oscillator 10C, the spin injection layer 10d and the magnetic pole 22 are made of the same material, and are integrally formed. The intermediate layer 10c, the oscillation layer 10b, and the electrode 10a are stacked in this order between the magnetic pole 22 and the magnetic shield 24. In this case, the magnetic pole 22 may be made of an alloy of a soft magnetic material such as Co, Fe, or Ni, or a material having an element such as B added to the alloy, with the exchange coupling length Lex and the spin diffusion length λs being taken into account.

To stabilize the spin injection layer 10d, the cross-sectional area of the spin injection layer 10d (the cross-sectional area of the region in which the magnetization oscillates in an integrated manner) needs to be four or more times greater than the cross-sectional area of the oscillation layer 10b. In this embodiment, however, the magnetic pole 22 also serves as the spin injection layer 10d. Therefore, the cross-sectional area of the region in which the magnetization oscillates in an integrated manner in the magnetic pole 22 should be set with the use of a cross-sectional area measured at a depth of approximately 20 nm from the intermediate layer 10c, as shown in FIG. 12.

This embodiment differs from the first and second embodiments in that the intermediate layer 10c is placed on the magnetic pole 22 side of the oscillation layer 10b, and the electrode 10a is placed on the magnetic shield 24 side of the oscillation layer 10b, so as to increase the spin torque transmissibility of the magnetic pole 22, and to lower the spin torque transmissibility of the magnetic shield 24.

In accordance with this embodiment, the reversal time of the spin torque oscillator can be minimized, as in the first embodiment.

Although the spin injection layer 10d and the magnetic pole 22 are made of the same material and are integrally formed, the spin injection layer 10d and the magnetic pole 22 may be made of different materials from each other. In such a case, it is preferable that the spin injection layer 10d and the magnetic pole 22 are ferromagnetically coupled to each other.

### FOURTH EMBODIMENT

Next, a magnetic recording apparatus in accordance with a fourth embodiment of the present invention is described.

The magnetic head of any of the first through third embodiments can be incorporated into a magnetic head assembly of a recording/reproducing type, and be mounted on a magnetic recording apparatus. The magnetic recording apparatus of this embodiment may have only a recording function, or may have both a recording function and a reproducing function.

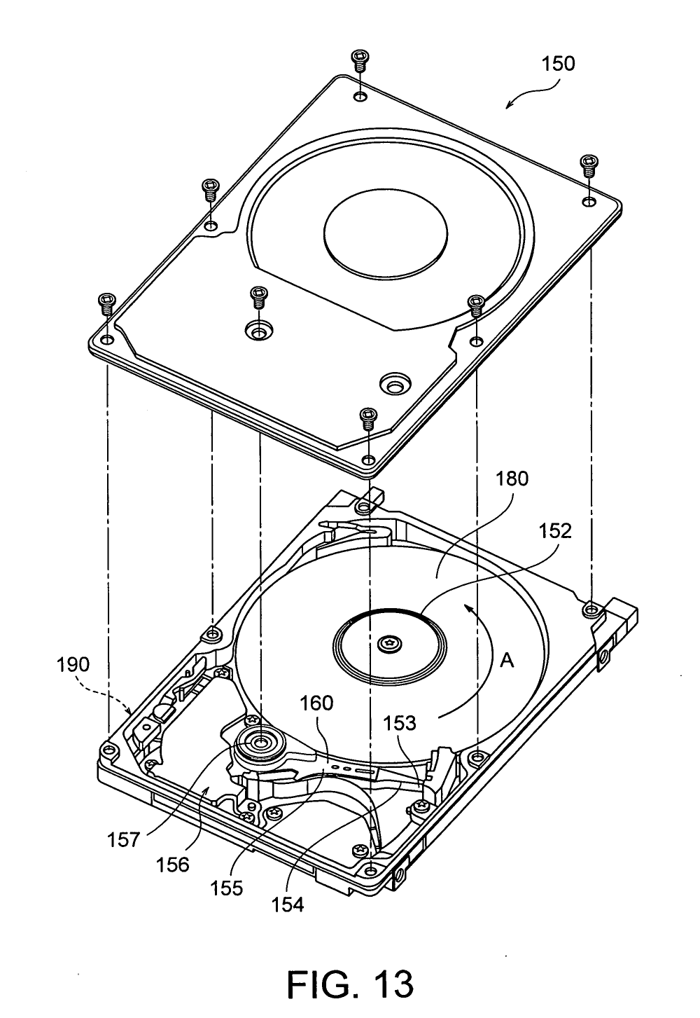

FIG. 13 is a schematic perspective view of an example structure of the magnetic recording apparatus in accordance with the fourth embodiment of the present invention. As shown in FIG. 13, the magnetic recording apparatus 150 of this embodiment is an apparatus that includes a rotary actuator. In FIG. 13, a recording medium disk 180 is attached to a spindle motor 152, and is rotated in the direction of the arrow A by a motor (not shown) that responses to a control signal transmitted from a drive control unit (not shown). The magnetic recording apparatus 150 of this embodiment may include two or more recording medium disks 180.

A head slider 153 that performs recording and reproduction of the information stored in the recording medium disk 180 is attached to the top end of a thin-film suspension 154. The head slider 153 has the magnetic head of one of the above embodiments mounted on the top end portion thereof.

When the recording medium disk 180 is rotated, the air bearing surface (ABS) of the head slider 153 is maintained at a predetermined floating distance from the surface of the recording medium disk 180. Alternatively, a “contact-running type” structure in which the head slider 153 is brought into contact with the recording medium disk 180 may be employed.

The suspension 154 is connected to an end of an actuator arm 155 having a bobbin unit or the like that holds the drive coil (not shown). A voice coil motor 156 that is a linear motor is provided at the other end of the actuator arm 155. The voice coil motor 156 may be formed with the drive coil (not shown) that is wound around the bobbin unit of the actuator arm 155, and a magnetic circuit that includes a permanent magnet and an opposed yoke arranged to face each other and sandwich the drive coil.

The actuator arm 155 is held by ball bearings (not shown) provided at upper and lower portions of a bearing unit 157, and rotatably slides by virtue of the voice coil motor 156.

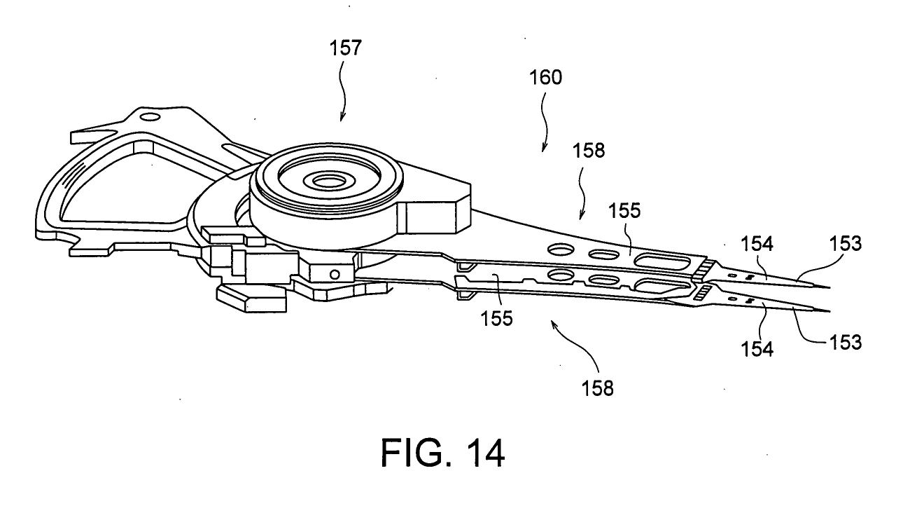

FIG. 14 shows an example structure of a part of a magnetic recording apparatus in accordance with this embodiment. FIG. 14 is an enlarged perspective view of a magnetic head assembly 160 excluding the actuator arm 155, seen from the disk side. As shown in FIG. 14, the magnetic head assembly 160 includes the bearing unit 157, a head gimbal assembly (hereinafter referred to as the HGA) 158 extending from the bearing unit 157, and a supporting frame 146 that extends from the bearing unit 157 in the opposite direction from the extending direction of the HGA 158 and supports the coil 147 of the voice coil motor. The HGA 158 includes the actuator arm 155 extending from the bearing unit 157, and the suspension 154 extending from the actuator arm 155.

The head slider 153 having the magnetic head of one of the first through third embodiments mounted thereto is attached to the top end of the suspension 154.

In short, the magnetic head assembly 160 of this embodiment includes the magnetic head of one of the first through third embodiments, the suspension 154 having the magnetic head mounted to its one end, and the actuator arm 155 connected to the other end of the suspension 154.

The suspension 154 has lead wires (not shown) for signal writing and reading, and the lead wires are electrically connected to the respective electrodes of the magnetic recording head incorporated into the head slider 153. Electrode pads (not shown) are also provided in the magnetic head assembly 160. In this specific example, eight electrode pads are provided. More specifically, there are two electrode pads for the coil of a magnetic pole, two electrode pads for a magnetic reproducing element, two electrode pads for a DFH (Dynamic Flying Height), and two electrode pads for the spin torque oscillator 10.

A signal processing unit 190 (not shown) that performs signal writing and reading on a magnetic recording medium with the use of a magnetic recording head is also provided. The signal processing unit 190 may be provided on the back face side of the magnetic recording apparatus 150 shown in FIG. 13, for example. The input and output lines of the signal processing unit 190 are connected to the electrode pads, and are electrically connected to the magnetic recording head.

As described above, the magnetic recording apparatus 150 of this embodiment includes: a magnetic recording medium; the magnetic head of one of the first through third embodiments; a moving unit that allows the magnetic recording medium and the magnetic head to move relative to each other, while keeping the magnetic recording medium and the magnetic head at a distance from each other or in contact with each other; a position control unit that places the magnetic head at a predetermined recording position on the magnetic recording medium; and a signal processing unit that performs signal writing and reading on the magnetic recording medium with the use of the magnetic head. The magnetic recording medium is the recording medium disk 180. The moving unit may include the head slider 153. The position control unit may include the magnetic head assembly 160.

As described above, the magnetic recording apparatus of this embodiment includes the magnetic head of one of the first through third embodiments. Accordingly, the reversal time of the spin torque oscillator can be minimized.

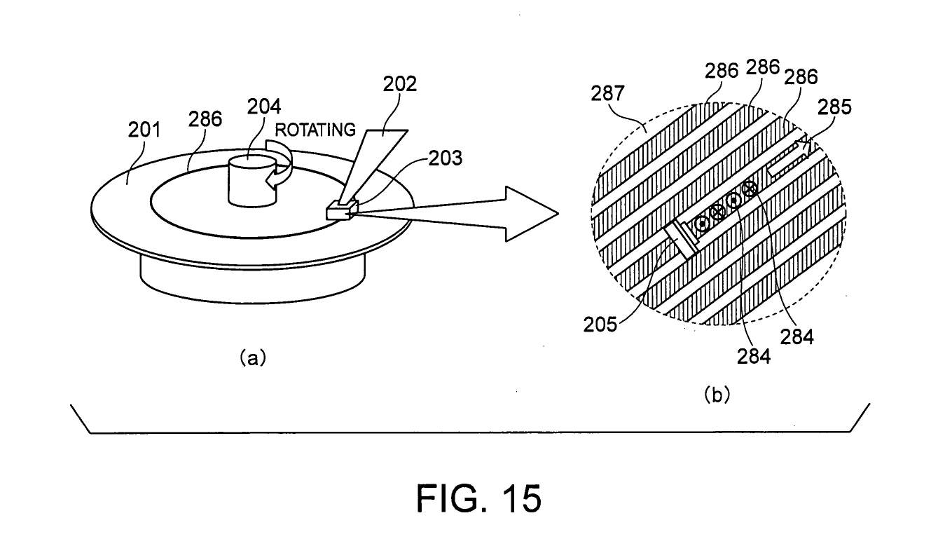

FIG. 15 illustrates a first specific example of a magnetic recording medium that can be used with the magnetic head of any of the embodiments of the present invention.

The magnetic recording medium 201 of this specific example has vertically-orientated multi-particle magnetic discrete tracks 286 that are isolated from one another by nonmagnetic material (or air) 287. As the magnetic recording medium 201 is rotated by a spindle motor 204 and is moved in the medium moving direction, recording magnetization 284 is formed by a magnetic head 205 mounted on a head slider 203. The head slider 203 is attached to the top end of a suspension 202. This suspension 202 has lead wires for signal writing and reading, and the lead wires are electrically connected to the respective electrodes of the magnetic head 205 incorporated into the head slider 203.

The width (TS) of the spin torque oscillator in the recording track width direction is made equal to or greater than the recording track width (TW), and equal to or smaller than the recording track pitch (TP), so that the decrease in the coercive force of the adjacent recording tracks due to the leakage high-frequency magnetic field generated from the spin torque oscillator can be greatly reduced. Accordingly, effective high-frequency field assist recording can be performed on the target recording track on the magnetic recording medium 201 of this specific example. Particularly, as a high-frequency magnetic field has high frequency and does not have a shielding effect, it is difficult to reduce blurred recording on adjacent recording tracks with a shield provided in the track width direction. With the use of the magnetic head of any of the embodiments of the present invention, the problem of erasing on adjacent recording tracks can be solved in a magnetic recording/reproducing apparatus that uses the magnetic recording medium 201 shown in FIG. 15. Also, in this specific example, the medium magnetic particle size can be further reduced (to a nanometer size) by employing a medium magnetic material with high magnetic anisotropy energy Ku such as FePt or SmCo on which writing cannot be performed with a conventional magnetic head. Thus, it is possible to realize a magnetic recording apparatus having a much higher linear recording density than ever even in the recording track direction (the bit direction).

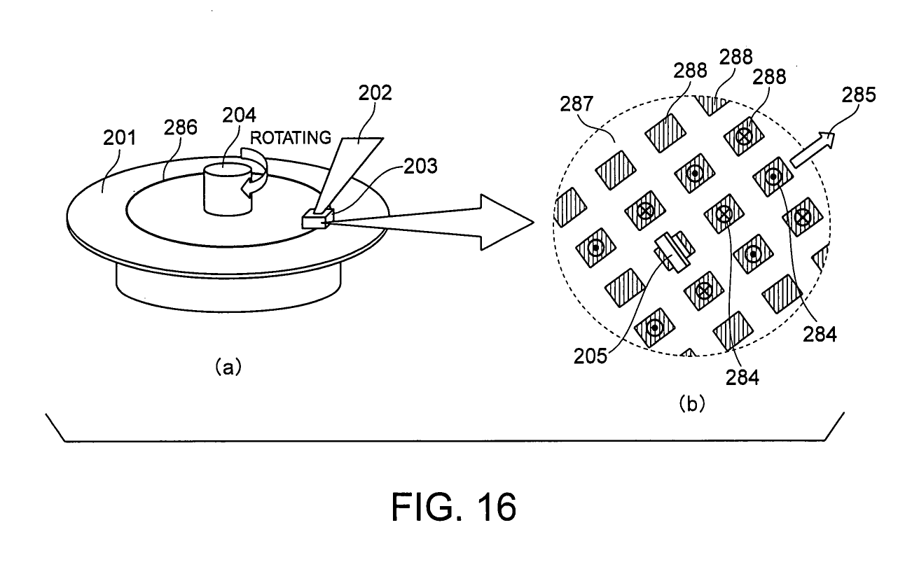

FIG. 16 illustrates a second specific example of a magnetic recording medium that can be used with the magnetic head of any of the embodiments of the present invention. The magnetic recording medium 201 of this specific example has magnetic discrete bits 288 that are isolated from one another by nonmagnetic material 287. As the magnetic recording medium 201 is rotated by a spindle motor 204 and is moved in the medium moving direction, recording magnetization 284 is formed by a magnetic head 205 mounted on a head slider 203.

In this specific example, the width (TS) of the spin torque oscillator in the recording track width direction is also made equal to or greater than the recording track width (TW), and equal to or smaller than the recording track pitch (TP), so that the decrease in the coercive force of the adjacent recording tracks due to the leakage high-frequency magnetic field generated from the spin torque oscillator can be greatly reduced. Accordingly, effective high-frequency field assist recording can be performed on the target recording track.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A magnetic head for high-frequency field assist recording, comprising:
a magnetic pole;
a magnetic shield that forms a magnetic circuit with the magnetic pole; and
a spin torque oscillator that is provided between the magnetic pole and the magnetic shield, and is formed with a stack structure including a first magnetic layer, a second magnetic layer, and an intermediate layer interposed between the first magnetic layer and the second magnetic layer, the first magnetic layer being made of a magnetic material of 200 Oe or smaller in coercive force, and a cross-sectional area of the first magnetic layer in a direction perpendicular to a stacking direction of the first magnetic layer being four or more times greater than a cross-sectional area of the second magnetic layer in a direction perpendicular to a stacking direction of the second magnetic layer.

2. The head according to claim 1, wherein the second magnetic layer is located on the magnetic pole side of the first magnetic layer.

3. The head according to claim 1, wherein the second magnetic layer is located on the magnetic shield side of the first magnetic layer.

4. The head according to claim 1, wherein the first magnetic layer is ferromagnetically coupled to the magnetic shield.

5. The head according to claim 1, wherein the first magnetic layer is made of the same material as the magnetic shield.

6. The head according to claim 1, wherein the first magnetic layer is ferromagnetically coupled to the magnetic pole.

7. The head according to claim 1, wherein the first magnetic layer is made of the same material as the magnetic pole.

8. A magnetic head for high-frequency field assist recording, comprising:
a magnetic pole;
a magnetic shield that forms a magnetic circuit with the magnetic pole; and
a spin torque oscillator that is provided between the magnetic pole and the magnetic shield, and is formed with a stack structure including a first magnetic layer, a second magnetic layer, and an intermediate layer interposed between the first magnetic layer and the second magnetic layer, the first magnetic layer being made of a magnetic material containing at least one element selected from the group consisting of Co, Ni, and Fe, and a cross-sectional area of the first magnetic layer in a direction perpendicular to a stacking direction of the first magnetic layer being four or more times greater than a cross-sectional area of the second magnetic layer in a direction perpendicular to a stacking direction of the second magnetic layer.

9. The head according to claim 8, wherein the second magnetic layer is located on the magnetic pole side of the first magnetic layer.

10. The head according to claim 8, wherein the second magnetic layer is located on the magnetic shield side of the first magnetic layer.

11. The head according to claim 8, wherein the first magnetic layer is ferromagnetically coupled to the magnetic shield.

12. The head according to claim 8, wherein the first magnetic layer is made of the same material as the magnetic shield.

13. The head according to claim 8, wherein the first magnetic layer is ferromagnetically coupled to the magnetic pole.

14. The head according to claim 8, wherein the first magnetic layer is made of the same material as the magnetic pole.

15. A magnetic recording apparatus comprising:
a magnetic recording medium;
the magnetic head for high-frequency field assist recording according to claim 8;
a motion control unit that controls the magnetic recording medium and the magnetic head to relatively move while facing each other in a floating or contact state;
a position control unit that controls the magnetic head to be located at a predetermined recording position on the magnetic recording medium; and
a signal processing unit that performs processing on a signal for writing on the magnetic recording medium and a signal for reading from the magnetic recording medium, using the magnetic head.

16. The apparatus according to claim 15, wherein the magnetic recording medium is a discrete track medium that has adjacent recording tracks having a nonmagnetic material interposed between the adjacent recording tracks.

17. The apparatus according to claim 15, wherein the magnetic recording medium is a discrete bit medium that has recording magnetic pattern portions regularly arranged and isolated from one another by a nonmagnetic material.
